(19) United States
(12) Patent Application Publication
(10) Pub. No.: US 2009/0012843 A1
(43) Pub. Date: Jan. 8, 2009

(54) Method for Managing a Shopping Website

(76) Inventor: Wen-Kai Ho, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/117,744

(22) Filed: May 9, 2008

(30) Foreign Application Priority Data
Jul. 6, 2007 (TW) 096124706

(51) Int. Cl. G06Q 10/00; G06Q 30/00

(52) U.S. Cl. 705/10; 705/27

(57) ABSTRACT

A method for managing a shopping website for preventing surging ordering products includes counting orders of a certain product during a predetermined duration, and then denying the ordering of the certain product if the orders of the certain product exceed a predetermined amount during the predetermined duration.

### BACKGROUND OF THE INVENTION

1. Field of the Invention

The present invention is related to a method for managing a shopping website, and more particularly, a method for preventing surging orders of a specific product of a shopping website.

2. Description of the Prior Art

Nowadays, online shopping has become an important shopping method. Website managers publish product information such as descriptions, photos, price, etc. on a shopping website, and consumers buy products from the website, completing the purchase contract online. Under certain conditions, due to mistakes, the website manager might publish a price that is much lower than a reasonable price, e.g. missing a zero, or publish wrong product specifications, accessories, or free gifts, which results in massive orders. However, the purchase contract is already completed, and the shopping website must sell the products to the consumers at an unreasonably low price, which creates a huge loss.

In order to solve the problem above, the prior art is able to limit the orders of each person, but cannot stop massive orders from a group of different people. Especially when a price of a certain product on the website is unreasonably low, consumers usually share this information, and post the link of the certain product in a web forum. When participants of the forum notice the sale information of the certain product, they click into the website of the certain product, and order the product. This consumer behavior causes a massive loss to the proprietor of the shopping website.

### SUMMARY OF THE INVENTION

It is therefore a primary objective of the present invention to provide a method for managing a shopping website, to alleviate problems of the prior art.

The present invention discloses a method for managing a shopping website for preventing surging ordering products. The method includes counting orders of a certain product during a predetermined duration, and then denying the ordering of the certain product if the orders of the certain product exceed a predetermined amount during the predetermined duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an embodiment of the present invention.

FIG. 2 illustrates a schematic diagram of a second embodiment of the present invention.

### DETAILED DESCRIPTION

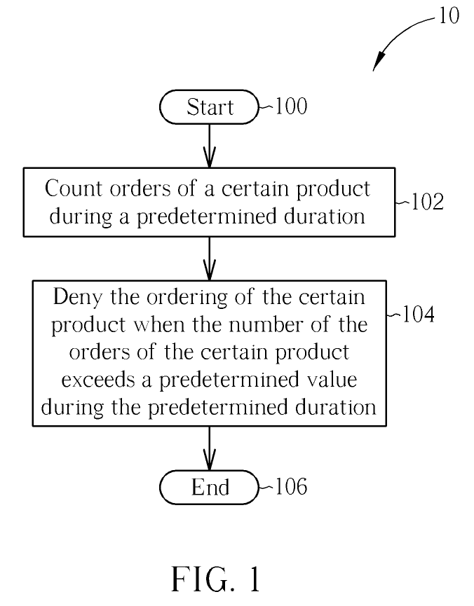

Please refer to FIG. 1, which illustrates a schematic diagram of a process 10 of an embodiment of the present invention. The process 10 is used for managing a shopping website, to prevent surging ordering products, and includes the following steps:

Step 100: Start.

Step 102: Count orders of a certain product during a predetermined duration.

Step 104: Deny the ordering of the certain product when the number of the orders of the certain product exceeds a predetermined value during the predetermined duration.

Step 106: End.

According to the process 10, the present invention counts the orders of a certain product during a predetermined duration, and then denies the ordering of the certain product when the number of the orders of the certain product exceeds a predetermined value during the predetermined duration, so that the loss to the supplier caused by the abnormal sale is alleviated. In other words, the process 10 of the present invention denies the ordering of the certain product when more than a certain number of consumers order the product. Under this condition, when abnormal sales of the certain product on the shopping website occur due to mistakes of setting prices, the present invention can deny the ordering of the product immediately, and control the loss of the shopping website.

As mentioned above, when consumers buy products through surfing the shopping website, and complete the purchase contract online, the shopping website must sell the product to the consumer according to the price on the purchase contract. If the price of the certain product is much lower than a market price because of incorrect settings, the product will be massively purchased. Through the process 10, when a certain product is sold massively during the predetermined duration, the present invention can deny the ordering of the product before the purchase contract is completed. In this way, if the price is published incorrectly, the order denying method of the present invention can reduce the loss of the shopping website, and without completing the purchase contract, the shopping website will not be legally responsible. On the contrary, the prior art can only limit the orders of a single user, but is not able to control the orders when many users buy the same product, which creates a loss that is difficult to make up.

Note that process 10 is merely an embodiment of the present invention. Those skilled in the art are able to make changes to the present invention. For instance, when a price of a certain product sold on a shopping website is much lower than average, consumers usually share this information, and post the web link of the certain product in websites such as forums, personal websites, message boxes, etc. When users see the sale information of the certain product, they click on the link of the website of the certain product, and purchase the product. If the purchase keeps going on, the loss of the shopping website increases massively. In order to solve the problem above, the present invention can also count the orders linked from a specific Uniform Resource Locator (URL) to a shopping website to buy a certain product during a predetermined duration according to a URL log of a web server, and decide if the orders are abnormal orders due to a price publishing error, and stop the sale of the product.

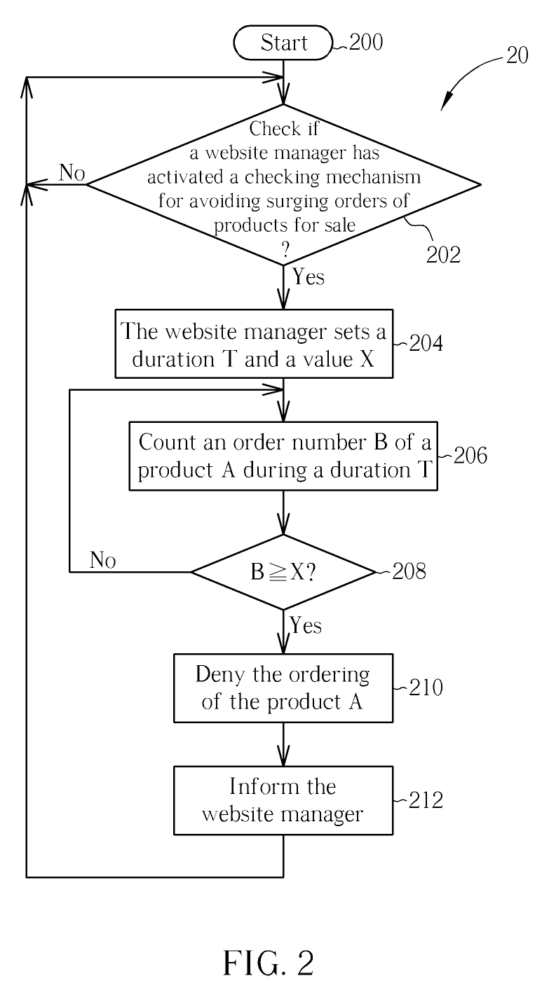

In addition, when the sale of the certain product is stopped because the number of orders exceeds the predetermined value during the predetermined duration, the present invention is able to inform the website manager, and the website manager can react to the situation after receiving the information. If the website manager decides that the situation is a normal hot sale, instead of a massive purchase that will harm the profits of the provider, the website manager may restore the sale of the product with a specific command. If the website manager has doubts about the hot sale situation, the sale of the product can remain halted, or the sale can be restored after modifying some website information. The website manager can also anticipate great sales of a certain product, and disable this mechanism of analyzing products of a shopping website and stopping the sale. Refer to FIG. 2 for related operations.

FIG. 2 illustrates a schematic diagram of a process 20 of a second embodiment of the present invention. The process 20 is for managing a shopping website, in order to prevent products from being massively ordered abnormally. The following steps are included:

Step 200: Start.

Step 202: Check if a website manager has activated a checking mechanism for avoid surging orders of products for sale. If the checking mechanism is activated, go to Step 204; if the checking mechanism is not activated, repeat Step 202.

Step 204: The website manager sets a duration T and a value X.

Step 206: Count an order number B of a product A during a duration T.

Step 208: Check if the order number B is greater than or equal to the value X. If so, go to Step 210; if not, go to Step 206.

Step 210: Deny the ordering of the product A.

Step 212: Inform the website manager and go back to Step 202 to let the website manager decide if the order of the product A should be restored, the duration T and the value X should be reset, or the checking mechanism should be deactivated.

Hence, through the process 20, after the website manager activates the checking mechanism for preventing products from being massively ordered, the website manager can set a duration T and a value X. If the order number B of the product A is less than the value X during the duration T, the sale of the product A can continue, and the process 20 continues to count the orders of the product A during the duration T. On the other hand, if the order number B of the product A is greater than or equal to the value X, the process 20 denies the ordering of the product A, and informs the website manager to take related actions, such as resetting the order of product A, resetting the duration T and the value X, or deactivating the checking mechanism. Under this condition, if a certain product of a shopping website has published a wrong price, causing surging orders, the present invention can terminate the sale of the product immediately, and decrease the loss to the shopping website.

Preferably, in the process 20, the present invention can also count the orders of the product A linked from a specific URL to the shopping website during the duration T according to the URL log of a web server, to decide if an abnormal, surging ordering is caused due to a wrong setting of the price of the product A. In this way, the abnormal ordering can be timely stopped.

According to regulations related to consumer rights, once the purchase contract is formed, the seller must sell the product to the buyer according to the price on the purchase contract. Hence, if a price of a certain product is set incorrectly and causes a surging ordering, due to the completed purchase contract, the seller (the shopping website) cannot cancel the deal unilaterally, which creates a loss that is difficult to recover. Under this condition, with the present invention, if a certain product of a shopping website is massively ordered during a predetermined duration, the present invention can deny the ordering of the certain product before the purchase contract is completed, and inform the website manager of the shopping website to carry on with related reactions. In this way, if the price of the product is published incorrectly, this checking mechanism can alleviate the loss to the shopping website. The purchase contract is not yet completed, so the shopping website does not have to carry out any legal responsibilities. On the contrary, the prior art is only able to limit the orders of a single buyer. If many buyers want to buy the same product, the prior art is not able to control the orders, which creates a loss that is difficult to recover.

For instance, if a price of a laptop computer on a shopping website is labeled incorrectly, missing a zero, such that the price is 1/10 of the original price, when consumers find out that the laptop computer on the website is much cheaper than average, they share this information on a web forum, and post the link of the purchase website on the web forum. Other people read the message and click the link of the purchase website, and many members of the web forum might buy the laptop computer because of the low price. Under this condition, according to the web server, we can know that the buyers are from the same specific web forum, so that the present invention can deny the ordering after the orders of the laptop computer reaches a predetermined number, and inform the website manager that the ordering of the laptop computer has been denied. The website manager assesses the conditions and terminates the ordering of the laptop computer, or corrects the price and continues the sale. Hence, the present invention prevents losses caused by abnormal massive sales.

In conclusion, the present invention can deny the ordering of a product when the order number of the product exceeds a predetermined value during a predetermined duration, to alleviate loss to a shopping website.

Those skilled in the art will readily observe that numerous modifications and alterations of the device and method may be made while retaining the teachings of the invention.

What is claimed is:

1. A method for managing a shopping website for preventing surging ordering products, the method comprising:
counting orders of a certain product during a predetermined duration; and
denying the ordering of the certain product if the orders of the certain product exceed a predetermined amount during the predetermined duration.

2. The method of claim 1, wherein counting the orders of the certain product during the predetermined duration is counting orders linked from a certain Uniform Resource Locator (URL) of the certain product during the predetermined duration.

3. The method of claim 2, wherein the orders of the certain product linked from the certain URL to the shopping website are counted during the predetermined duration according to a URL log of a web server.

4. The method of claim 2, wherein the certain URL corresponds to a forum website.

5. The method of claim 1 further comprising informing a website manager after the order of the certain product is denied.

6. The method of claim 1, further comprising adjusting the predetermined duration and the predetermined amount according to a selling condition prediction.

7. The method of claim 1, further comprising utilizing a certain command to restore the order of the certain product.
